(19) United States
(12) Patent Application Publication
(10) Pub. No.: US 2013/0081548 A1
(43) Pub. Date: Apr. 4, 2013

(54) WASTE COMPACTOR

(71) Applicants: Kirk Warren, Cherry Hill, NJ (US); Alex Batista, Cherry Hill, NJ (US); Peter DesJardins, Cherry Hill, NJ (US)

(72) Inventors: Kirk Warren, Cherry Hill, NJ (US); Alex Batista, Cherry Hill, NJ (US); Peter DesJardins, Cherry Hill, NJ (US)

(73) Assignee: WASTEQUIP, LLC, Charlotte, NC (US)

(21) Appl. No.: 13/595,529

(22) Filed: Aug. 27, 2012

Related U.S. Application Data
(60) Provisional application No. 61/528,083, filed on Aug. 26, 2011.

(51) Int. Cl. B30B 15/00

(52) U.S. Cl. CPC B30B 15/0094
USPC 100/99

(57) ABSTRACT

The invention is generally applicable to a waste compactor. More specifically, the invention is applicable to a waste compactor including a monitoring system which enables an operator to view the interior or exterior of one or more portions of the waste compactor.

### RELATED APPLICATION

This application is a U.S. Non-Provisional Patent Application which claims priority to U.S. Provisional Patent Application Serial No. 61/528,083, filed on Aug. 26, 2011 and titled “Waste Compactor,” which is hereby incorporated by reference in its entirety.

### TECHNICAL FIELD

The invention is generally applicable to a waste compactor. More specifically, the invention is applicable to a waste compactor including a monitoring system which enables an operator to view the interior or exterior of one or more portions of the waste compactor.

### BACKGROUND OF INVENTION

Waste compactors are used to compact waste and refuse materials to reduce the size and volume of the materials. It is desirable to compact waste and refuse materials for many reasons. For example, it is desirable to compact waste and refuse materials to reduce the space that is taken up by the materials in waste containers, dumps, landfills, etc. It is also desirable to compact waste and refuse materials to the reduce how frequently a waste container must be emptied, thus reducing the costs and effort associated with the emptying of the waste container.

It is desirable to provide a waste compactor which operates in an energy efficient manner. It is also desirable to provide a waste compactor which decreases the number of compaction cycles necessary to fill a given waste container with compacted waste and refuse materials. Furthermore, it is also desirable to provide a waste compactor which includes a monitoring system which enables an operator to view the interior of one or more portions of the waste compactor to: (i) promote safety and diminish the likelihood of accidental injury or death of an individual located within the waste compactor; (ii) increase the efficiency of the waste compactor by preventing unnecessary cycling of the compactor upon a determination that the compactor is not yet filled to capacity based upon a visual inspection of the interior of the waste compactor; and/or (iv) ensure that no obstructions are present in any portion of the waste compactor (e.g., charge box, container, loading chute, etc.). The present invention has applicability to a variety of compactors, including but not limited to self contained compactors, stationary compactors, vertical compactors, apartment style compactors, pre-crusher compactors as well as other compactor types.

Features and advantages of the invention will be set forth in part in the description which follows, and in part will be obvious from the description, or may be learned by practice of the invention. The accompanying drawings, which are incorporated in and constitute a part of this specification, illustrate several embodiments of the invention, and together with the description, serve to explain the principles of the invention.

### BRIEF DESCRIPTION OF THE DRAWINGS

FIG. 1 shows a perspective view of one non-limiting embodiment of a waste compactor.

### DETAILED DESCRIPTION OF THE INVENTION

The present invention will now be described with occasional reference to specific embodiments of the invention. This invention may, however, be embodied in different forms and should not be construed as limited to the embodiments set forth herein. Rather, these embodiments are provided so that this disclosure will fully convey the scope of the invention to those skilled in the art and are not intended to limit the scope of the invention in any way.

Also, while the detailed exemplary embodiments described in the specification and illustrated in the drawings relate to a self contained type compactor, in which a compacting unit is structurally integrated with a waste container as a unitary structure, it should be understood that the waste compactor described herein has applicability to a variety of compactors, including but not limited to stationary compactors, vertical compactors, apartment style compactors, pre-crusher compactors as well as other compactor types including compactors which are separable from and usable with a variety of waste containers.

Except as otherwise specifically defined herein, all terms used herein have the same meaning as commonly understood by one of ordinary skill in the art to which this invention belongs. The terminology used in the description of the invention herein is for describing particular embodiments only, and is not intended to be limiting of the invention. As used in the description of the invention, the singular forms “a,” “an,” and “the” are intended to include the plural forms as well, unless the context clearly indicates otherwise.

Unless otherwise indicated, all numbers expressing quantities, properties, and so forth as used in the specification are to be understood as being modified in all instances by the term “about.” Accordingly, unless otherwise indicated, the numerical properties set forth in the following specification are approximations that may vary depending on the desired properties sought to be obtained in embodiments of the present invention. Notwithstanding that the numerical ranges and parameters setting forth the broad scope of the invention are approximations, the numerical values to the extent that such are set forth in the specific examples are reported as precisely as possible. Any numerical values, however, inherently contain certain errors necessarily resulting from error found in their respective measurements.

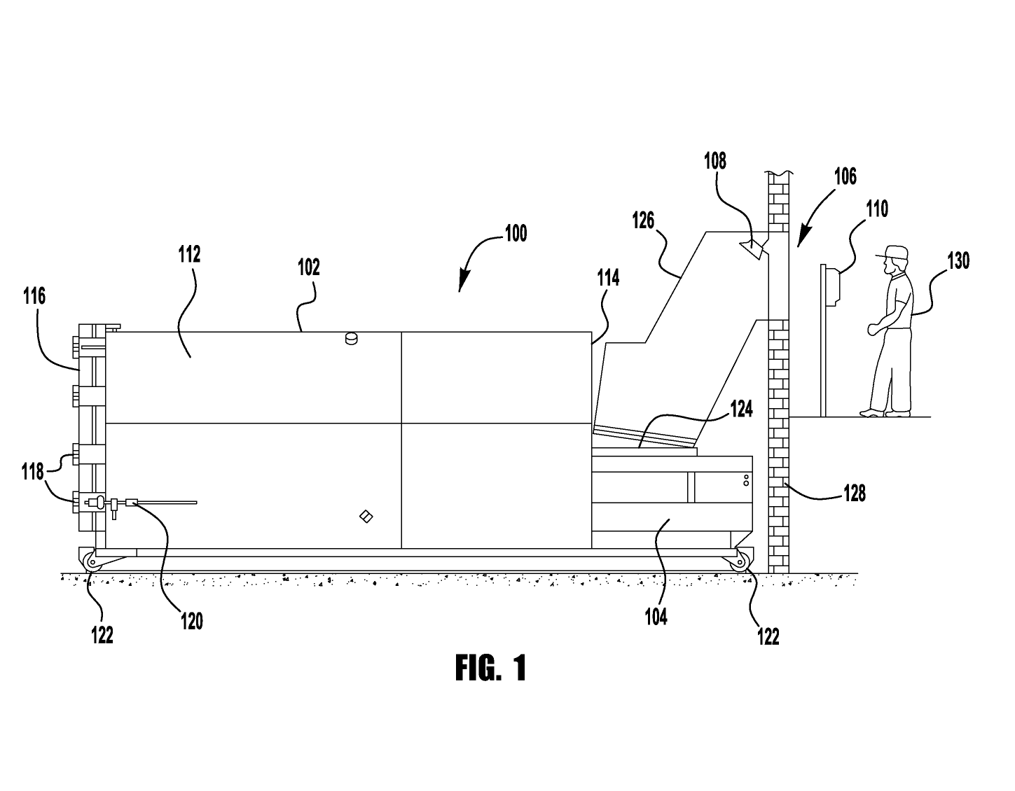

FIG. 1 shows one exemplary embodiment of a waste compactor 100. Referring to FIG. 1, the waste compactor 100 generally includes a container portion 102, a charge box portion 104 and a monitoring system 106. The monitoring system 106 includes at least one camera 108 and at least one display device 110. The monitoring system 106 allows an operator of the waste compactor 100 to view the interior and/or exterior of the charge box portion 104, container portion 102 and/or other portion of the waste compactor 100. In various exemplary embodiments, the monitoring system 106 serves to: (i) promote safety and diminish the likelihood of the accidental injury or death of an individual located within the waste compactor 100; (ii) increase the efficiency of the waste compactor 100 by preventing unnecessary cycling of the waste compactor 100 if it is determined that the waste compactor 100 is not yet filled to capacity based upon a visual inspection of the interior of the waste compactor 100; and/or (iv) ensure that no obstructions are present in any portion of the waste compactor 100 (e.g., charge box portion 104, container portion 102, loading chute 126, etc.).

The container portion 102 is a enclosed container made up of a plurality of side walls 112, a front wall 114 and an end wall 116. The end wall 116 of the illustrated embodiment is hingebly attached to the container portion 102 by a plurality of hinges 118. The end wall 116 is pivotable between a closed position and an open position on the hinges 118 to permit the emptying of the container portion 102. The waste compactor 100 of various embodiments may include a lock 120 or other device to retain the end wall 116 in the closed position until it is desired that the container portion 102 be emptied. In additional embodiments, waste compactor 100 may include a lock or other device to retain the end wall 116 in the opened position during emptying to ensure that it does not interfere with the process of emptying the container portion 102.

The shape and configuration of each of walls 112, 114, 116 of the container portion 102 of the waste compactor 100 may vary in various embodiments. In addition, the overall shape and configuration of the container portion 102 and the overall waste compactor 100 may vary in various embodiments and the shape and configuration of the container portion 102 and the overall waste compactor 100 are not limited to the shape and configuration of the exemplary embodiment of the container portion 102 and the overall waste compactor 100 shown in FIG. 1.

The container portion 102 of the present application may have a variety of different sizes in various embodiments. For example, various embodiments of the container portion 102 may be of a variety of suitable sizes, including but not limited to 20 cubic yards, 25 cubic yards, 30 cubic yards, 34 cubic yards, 35 cubic yards or various other sizes.

The walls 112, 114, 116 of the container portion 102 of the waste compactor 100 according to the present invention may be formed of one or more of a variety of suitable materials. The particular material is generally selected to be compatible with the intended purpose and desired qualities of the waste compactor 100. For example, in various embodiments, the walls 112, 114, 116 of the container portion 102 may be made from one or a combination of metals, such as steel or aluminum.

The illustrated embodiment of the waste compactor 100 includes a plurality of wheels 122 which support the waste compactor 100 and allow it to be moved if desired. However, additional embodiments of the waste compactor 100 may be provided without any such wheels. Additional embodiments of waste compactor 100 may include legs or other types of supports that serve to raise the waste compactor 100 off of the ground. Furthermore, in additional embodiments of waste compactor 100, the bottom of waste compactor 100 may rest directly on the ground or other supporting surface and not be raised up in any manner.

Referring again to FIG. 1, the illustrated embodiment of waste compactor 100 includes a charge box portion 104. The charge box portion 104 includes a hopper opening 124 to permit access to the charge box portion 104 for loading the charge box portion 104 with waste materials for compaction and loading into the container portion 102. The charge box portion 104 is constructed from side walls designed and adapted to withstand the forces generated by the compaction of the waste materials compacted within the charge box portion 104. The waste materials inserted into the charge box portion 104 via the hopper opening 124 are forced into the container portion 102 and/or compacted by a ram (not shown) driven by a hydraulic cylinder (not shown) or similar device. Once the container portion 102 is sufficiently full, the ram operates to compact the waste materials within the container portion 102.

The operation of the hydraulic cylinder or similar device is driven by a power unit (not shown) (which may include, for example, one or more hydraulic pump, hydraulic tank, electric motor, directional valves, etc.) and controlled by an electronic controller (not shown) (which may include, for example, one or more transformer, motor starter, relays, fuses, switches, circuit boards, programmable controllers, etc.) (not shown). The hydraulic ram moves horizontally, back and forth, within the charge box portion 104 and container portion 102. The hydraulic ram serves to force the waste material located within the charge box portion 104 into the container portion 102. Once the container portion 102 is sufficiently filled with waste material, the hydraulic ram then serves to compact the waste material within the container portion 102. After the completion of multiple, successive cycles of loading the charge box portion 104 with waste materials, forcing the contents of the charge box portion 104 into the container portion 102, and/or compacting the contents of the container portion 102, the container portion 102 will become filled. Once the container portion 102 is filled with compacted waste, the container portion 102 is then emptied.

The shape, orientation and configuration of the charge box portion 104 of the waste compactor 100 may vary in various embodiments. The charge box portion 104 may also have a variety of different sizes in various embodiments. The charge box portion 104 of the illustrated embodiment shown in FIG. 1 has a capacity of approximately 4 cubic yards. The charge box portion 104 of the illustrated embodiment has a capacity that is generally twice that of a charge box portion 104 of a traditional waste compactor. The charge box portion 104 of the illustrated embodiment has an operational capacity with a width of approximately 58 inches, length of approximately 72 inches and a height of 30 inches. A traditional charge box with a 2 cubic yard capacity has an operational capacity with a width of approximately 40 inches, length of 60 inches and height of 26 inches. Due to this charge box capacity increase relative to a typical waste compactor, 50% fewer compacting cycles are necessary to fill a particular container using the charge box of the illustrated embodiment (as compared to the cycles that would be required if a conventional 2 cubic yard capacity charge box were used). In addition, the operation of the larger capacity charge box portion 104 of the illustrated embodiment consumes less energy (e.g., kilowatt hours) to fill a particular container than the operation of a conventional charge box would consume. However, it should be understood that various additional embodiments of the charge box portion 104 of the waste compactor 100 of the present invention may be a variety of suitable sizes, including but not limited to 2 cubic yards, 3 cubic yards, or various other sizes.

Referring again to FIG. 1, the illustrated embodiment of waste compactor 100 includes a monitoring system 106 which includes at least one camera 108 and at least one display device 110. One or more cameras 108 may be located anywhere around, within or outside any of the various portions of the waste compactor 100, including but not limited to the container portion 102, charge box portion 104 and optional loading chute 126 (described below), to permit an operator to view the portion of the waste compactor 100. One or more display devices 110 may be located remotely of the one or more cameras 108 to provide a user with a visual display of the view of the one or more cameras 108. The one or more cameras 108 may be thermographic cameras, infrared cameras, infrared thermography (IRT), thermal imaging, and/or thermal video cameras to provide for a visible depiction of the dark interior of the charge box portion 104, container portion 102 or other portion of the waste compactor 100. One display device 110 may be associated with multiple cameras 108, which are located at various locations relative to the waste compactor 100, to provide for visualization of multiple areas of the waste compactor 100 on a single display device 110. In such embodiments, the display device 100 may be adapted to display the view of each of the multiple cameras 108 simultaneously, be adapted to display the view of each of the multiple cameras separately for a predetermined period in a cycled manner, or be adapted to display the view of one or more of the cameras selected by a user for viewing at a particular time. In certain embodiments, multiple display devices 110 may be located at various locations relative to the waste compactor 100 that are each associated with a separate, discrete camera 108 or group of cameras. In various additional embodiments, multiple display devices may be located at various locations relative to the waste compactor 100 that are each associated with the same camera 108 or group of cameras.

In the illustrated embodiment of the waste compactor 100, the waste compactor includes an optional loading chute 126. The loading chute 126 is adapted to allow a user 130 of the waste compactor 100 to load the charge box portion 104 of the waste compactor 100. For example, the loading chute 126 may be adapted to allow a user 130 of the waste compactor 100 to load the charge box portion 104 of the waste compactor 100 from the interior of a building or other structure. The loading chute 126 of various embodiments can have a variety of shapes and configurations. For example, the loading chute may have a generally rectangular or circular interior cross-section. Loading chute 126 may be constructed from a variety of suitable materials, such as one or a combination of metals, such as steel or aluminum, or one or a combination of thermoplastic or elastomeric materials. The loading chute 126 includes an inlet end which is accessible from the interior of a building other structure. The loading chute 126 of various embodiments of waste compactor 100 may traverse or pass through one or more walls 128 of a structure or other similar barriers to reach the location of the waste compactor 100.

In many embodiments of the waste compactor 100, the waste compactor is controlled by the user 130 without the user being able to view the interior of the charge box portion 104 and/or container portion 102. In additional embodiments of the waste compactor 100 which include a loading chute 126, the waste compactor is controlled by the user 130 from the interior of the building or other structure. In such embodiments, the user 130 often does not have a view of the waste compactor 100 or the interior of the charge box portion 104, container portion 102, and/or loading chute 126. In this manner, it is often necessary that the user 130 initiate the compaction of the charge box portion 104 without being able to view the interior of the charge box portion 104. Under these circumstances, it is possible that the compaction of the charge box portion 104 of the waste compactor 100 could be initiated with someone inside of the charge box portion 104 who is conducting maintenance of the charge box portion 104 or in the charge box portion 104 for some other reason. Without visualization of the interior of the charge box portion 104, it is also possible, that a user may initiate compaction of the charge box portion 104 prior to the charge box portion 104 being loaded to full capacity. The compaction of the charge box portion 104 prior to it being loaded to full capacity results in inefficiency due to the power consumption associated with a full compaction cycle even though the charge box portion 104 is not fully filled. Without visualization of the interior of the charge box portion 104, container portion 102, and/or loading chute 126, it is also possible, that an obstruction may go unnoticed that resides in the charge box portion 104, container portion 102 or loading chute and which should be removed for optimal operation of the waste compactor 100.

For this reason, it is desirable that the user 130 of the waste compactor 100 be afforded a view of the interior of one or more portions of the waste compactor 100. In the illustrated embodiment of the waste compactor 100 shown in FIG. 1, a camera 108 is located within the loading chute 126 to provide a view of the interior of the loading chute 126 as well as a view into the hopper opening 124 of the charge box portion 104. A user 130 can view the interior of the loading chute 126 and the charge box portion 104 on the display 110, located remotely of the waste compactor 100, prior to initiating a compaction cycle. In this manner, the user can view the interior of the loading chute 126 and charge box portion 104 to confirm that no one is located within the loading chute 126 or charge box portion 104.

In addition, the user 130 can ascertain the fullness of the charge box portion 104 via the display 110 and ensure that a compaction cycle is not initiated until the charge box portion 104 is filled to full capacity, thus increasing the efficiency of the waste compactor 100 by eliminating any compaction cycles from occurring when the charge box portion 104 isn't fully filled. The user 130 can also determine via the display 110 whether the loading chute 126 and/or charge box portion 104 may be obstructed by waste material and whether any such waste material must be removed from the loading chute 126 and/or charge box portion 104 to permit for optimum performance of the waste compactor 100.

While the illustrated embodiment of the waste compactor 100 includes one camera 108 located within the loading chute 126 of the waste compactor, it should be understood that the camera 108 could be located within various other portions of the waste compactor 100. For example, the camera 108, could be mounted within the charge box portion 104, the container portion 102 or some other portion of the waste compactor. Also, additional embodiments of the waste compactor 100 may include multiple cameras 108 located at various positions around the exterior or within various portions of the waste compactor 100. Also, as mentioned previously, even though the illustrated embodiment includes only one display device 110, additional embodiments of the waste compactor may include additional display devices 110.

While the illustrated embodiment of the waste compactor 100 includes a loading chute 126, it should be understood that the monitoring system 106 of the present invention may be utilized with a wide variety of waste compactors 100. For example, the waste compactor 100 may be provided with an enclosure or room surrounding the charge box portion 104 to shield the charge box portion 104 from the elements. In such embodiments, the waste compactor 100 may include one or more cameras 108 located at various positions within the enclosure and/or the charge box portion to permit a view of the interior of the enclosure and/or charge box portion.

Also, as mentioned previously, while the detailed exemplary embodiments described in the specification and illustrated in the drawings relate to a self contained type compactor, in which a compacting unit is structurally integrated with a waste container, it should be understood that the waste compactor described herein has applicability to a variety of compactors, including but not limited to stationary compactors, vertical compactors, apartment style compactors, pre-crusher compactors as well as other compactor types.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasable or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A waste compactor comprising:
a compactor unit for receiving material for compaction; and
a monitoring system including at least one camera and at least one display device, wherein the monitoring system provides for the visualization of the interior of at least a portion of the waste compactor by an operator of the waste compactor.

2. The waste compactor of claim 1 further comprising a container.

3. The waste compactor of claim 2, wherein the compactor unit comprises a charge box portion.

4. The waste compactor of claim 3, wherein the monitoring system provides visualization of at least a portion of the interior of the charge box portion.

5. The waste compactor of claim 3 further comprising a loading chute.

6. The waste compactor of claim 5, wherein the monitoring system provides visualization of at least a portion of the interior of the loading chute.

7. The waste compactor of claim 3, wherein the charge box portion has a capacity of approximately 4 cubic yards.

8. The waste compactor of claim 1, wherein the monitoring system comprises one display device associated with a plurality of cameras.

9. The waste compactor of claim 1 wherein the monitoring system comprises a plurality of display devices each associated with at least one camera.

10. The waste compactor of claim 3, wherein the monitoring system comprises a plurality of cameras, and wherein at least one of the plurality of cameras provides visualization of at least a portion of the interior of the container and at least one of the plurality of cameras provides visualization of at least a portion of the interior of the charge box portion.

11. The waste compactor of claim 5, wherein the monitoring system comprises a plurality of cameras, and wherein at least one of the plurality of cameras provides visualization of at least a portion of the interior of the charge box portion and at least one of the plurality of cameras provides visualization of at least a portion of the interior of the loading chute.

12. The waste compactor of claim 5, wherein the monitoring system comprises a plurality of cameras, and wherein at least one of the plurality of cameras provides visualization of at least a portion of the interior of the container and at least one of the plurality of cameras provides visualization of at least a portion of the interior of the loading chute.

13. A waste compactor comprising:
a container
a charge box portion for receiving material for compaction; and
a monitoring system including at least one camera and at least one display device, wherein the monitoring system provides for the visualization of the interior of at least a portion of the waste compactor by an operator of the waste compactor.

14. The waste compactor of claim 13, wherein the monitoring system provides visualization of at least a portion of the interior of the charge box portion.

15. The waste compactor of claim 13 further comprising a loading chute.

16. The waste compactor of claim 15, wherein the monitoring system provides visualization of at least a portion of the interior of the loading chute.

17. The waste compactor of claim 13, wherein the monitoring system comprises a plurality of cameras, and wherein at least one of the plurality of cameras provides visualization of at least a portion of the interior of the container and at least one of the plurality of cameras provides visualization of at least a portion of the interior of the charge box portion.

18. The waste compactor of claim 15, wherein the monitoring system comprises a plurality of cameras, and wherein at least one of the plurality of cameras provides visualization of at least a portion of the interior of the charge box portion and at least one of the plurality of cameras provides visualization of at least a portion of the interior of the loading chute.

19. The waste compactor of claim 15, wherein the monitoring system comprises a plurality of cameras, and wherein at least one of the plurality of cameras provides visualization of at least a portion of the interior of the container and at least one of the plurality of cameras provides visualization of at least a portion of the interior of the loading chute.

20. A waste compactor comprising:
a container
a charge box portion for receiving material for compaction;
a loading chute; and
a monitoring system including at least one camera and at least one display device, wherein the monitoring system provides for the visualization of at least a portion of the interior of at least one of the container, charge box portion and loading chute.
